(19) United States
(12) Patent Application Publication
(10) Pub. No.: US 2007/0283794 A1
(43) Pub. Date: Dec. 13, 2007

(54) Machine tool holder having internal coolant supply and cutter retaining and coolant distribution cutter insert retaining clamp assembly

(76) Inventor: Enrico R. Giannetti, East Bernard, TX (US)

Correspondence Address: JAMES L. JACKSON;James L. Jackson, PC, 10723 Sugar Hill Dr., HOUSTON, TX, 77042, US

(21) Appl. No.: 11/515,587

(22) Filed: Sep. 5, 2006

Related U.S. Application Data
(63) Continuation-in-part of application No. 11/452,154, filed on Jun. 13, 2006.

(51) Int. Cl. B23B 29/00; B32B 29/00

(52) U.S. Cl. 82/158

(57) ABSTRACT

A boring bar has a shank having a cutter support head at one end. A flow passage extends to the cutter support head and intersects a transverse flow passage that is defined in part by a clamp screw passage of the head. A metal cutting insert is clamped to the cutter support head by a clamp that is secured by a clamp screw being threaded into the clamp screw passage. The clamp screw defines an internal or external passage that communicates with the internal coolant fluid passage and completes a coolant distribution circuit. The clamp defines an internal coolant fluid passage having a discharge opening located and oriented to direct a jet of coolant fluid onto the metal cutting insert immediately at the site of cutting engagement within the rotating workpiece. The cutter support head also has a passage and chip removal jet nozzle that orients a jet of coolant fluid adjacent the cutter insert for remove metal chips during machining.

This is a Continuation-in-Part application based on pending application Ser. No. 11/452,154 which was filed on Jun. 13, 2006 by Enrico R. Giannetti and entitled “Boring Bar Having Internal Coolant Supply And Cutter Retaining Nozzle”.

### BACKGROUND OF THE INVENTION

1. Field of the Invention

The present invention relates generally to machine tool holders such as boring bars that are mounted to machine tools and are used for external machining operations or for boring internal surfaces in work pieces that are typically rotated by a machine tool. More particularly the present invention pertains to machine tool holders such as boring bars having an internal coolant supply to discharge a liquid coolant and cutting fluid medium immediately at the site of metal cutting by a metal cutting insert of a machine tool holder. Even more specifically, a coolant fluid distributing nozzle also functions as a clamp for releasably securing a metal cutting insert to the cutter support head of a boring bar or other machine tool holder.

### Definitions:

The terms JETSTREAM™, SCREW-LOCK™, LAY-DOWN™, ON-EDGE™, and DOR-NOTCH™, as identified herein are trademarks of applicant, Dorian Tool International, 615 County Road 219, East Bernard, Tex. 77435.

While the “coolant fluid” or “coolant medium” described herein is often referred to simply as a fluid or simply as coolant, it is intended that these terms are of sufficiently broad scope as to comprise a liquid, a gas such as air, a liquid/gas mixture or any suitable flowing medium that may be used to cause cooling of the machining interface of a metal cutting insert with a moving workpiece.

2. Description of the Prior Art

A machine tool holder having a coolant fluid distribution system is shown in U.S. Pat. No. 6,652,200 of Kraemer. In this case, a plate member 30 is secured to a tool head and has multiple grooves that define coolant passages and with discharge openings arranged to project streams or jets of coolant fluid toward a machining interface. A coolant fluid supply passage is defined within the head of the tool and receives coolant fluid via a supply line having a connector that is attached to the bottom part of the tool head. A top plate is attached to the head of the tool holder and defines one or more grooves that cooperate with the head to define passages for coolant flow to a cutter insert. The top plate does not function as a clamp to retain a cutter insert in cutting position with respect to the head of the tool holder. Rather, the top plate simply cooperates with the structure of the tool head to define coolant flow passages externally of the tool head.

During metal cutting operations, especially when heavy cuts of metal are taken during rough metal cutting operations or when a hard metal is being machined, it is typical for the metal cutting machine to be provided with a coolant fluid conduit through which a coolant and metal cutting fluid medium is pumped to the site of metal cutting. Typically, a fluid supply conduit, such as a flexible coolant supply hose in communication with the discharge of a coolant supply pump, is provided which can be selectively oriented for delivery of the flowing coolant fluid medium to the cutter insert of the machine tool. The continuous supply of coolant fluid to the metal cutting site minimizes heat build-up at the metal cutting site and thus maintains lower working or cutting temperature of the metal cutting element and ensures its extended service life.

When metal cutting operations are carried out by a boring bar internally of a rotating work-piece, such as is the case when boring operations are being carried out, the boring bar being used can have considerable length, thus making it difficult to efficiently support a coolant supply tube or hose and conduct an adequate supply of coolant fluid to the immediate region of the metal cutting insert of the boring bar. It is desirable, therefore, to provide a metal boring tool system that does not require a coolant supply conduit to be supported along the length of a boring bar and which ensures efficient and adequate delivery of coolant fluid to the immediate site of metal cutting for maintaining the cutting tool and the metal being cut within a predetermined temperature range. It is also desirable to provide a machine tool holder which, in addition to the provision of one or more jets of coolant fluid for cooling of a machining interface, also provides one or more jets of chip flushing fluid from an internal coolant fluid supply which continuously flush away any accumulation of loose machining chips that might otherwise interfere with efficient machining operations.

For application of a coolant medium to a metal cutting site, a spray or distribution nozzle is typically mounted on or fixed to the cutting head of a cutter insert support machine tool. The spray or distribution nozzle defines one or more fluid flow passages that are in fluid communication with one or more coolant supply passages or lines. The fluid discharge outlet or outlets of the spray or distribution nozzle are arranged to direct one or more jets of coolant fluid onto the cutter insert of the tool so as to impinge at the point of cutter engagement with the rotating work-piece. In the case of some machine tools of considerable length, such as boring bar tools, it is difficult to mount coolant supply tubes to the tools; thus adequate cooling of cutter inserts is not efficiently achieved. It is desirable therefore to provide a machine tool having an internal coolant supply passage and having a coolant distribution nozzle that provides a jet or spray of coolant fluid at the immediate site of metal cutting regardless of the length of the machine tool.

Positioning coolant supply tubes on or near cutting tools often obscures the metal cutting site to the point that visual inspection of the metal cutting operation is impaired. Also, the use of mounts to provide clamping or retaining support for replaceable metal cutting inserts and additional mounts to support one or more coolant nozzles on machine tools typically makes the machine tools quite complex and expensive. It is desirable therefore, to provide a machine tool having a single mounting or retaining mechanism for securing a replaceable cutter element to the head portion of the tool and for supporting a coolant distribution nozzle that is positioned for application of coolant fluid to the immediate interface of metal cutting. When high pressure application of coolant to a metal cutting interface is needed, tubes for conducting the coolant to the metal cutting interface are often impractical especially when long tube lengths are also needed. Thus it is desirable to provide a suitable means for developing high pressure jets of coolant that are emitted from openings or jet nozzles located close to the metal cutting interface and causing the jets of coolant fluid to be directed precisely at the metal cutting interface. It is also desirable to provide one or more jets of high pressure coolant that are also located in close proximity to the metal cutting interface and to precisely direct the coolant jets for continuous removal of any metal chips that might otherwise tend to build up and interfere with the machining process and/or interfere with cooling of the metal cutting interface.

### SUMMARY OF THE INVENTION

It is a principal feature of the present invention to provide a novel cutter insert support machine tool, such as a boring bar, having a single mounting or retaining mechanism for securing a replaceable cutter element to the head portion of the tool and for mounting a coolant distribution nozzle that is positioned on the head portion of the tool for application of coolant fluid to the immediate interface of the metal cutting insert with a rotating work-piece that is being machined.

It is another feature of the present invention to provide a novel machine tool having a coolant supply passage therein and having a coolant supply nozzle in fluid communication with the coolant supply passage and having one or more distribution openings located immediately adjacent the machining interface and wherein the coolant supply nozzle and its retainer bolt also serves a clamping function to secure a replaceable metal cutting insert to the head portion of the tool.

It is a principal feature of the present invention to provide a novel machine tool, such as a boring bar, having one or more internal passages for flow of coolant and/or cutting fluid medium at least in the head portion thereof and having a metal cutting insert mount mechanism thereon that defines one or more fluid distribution passages directing the flow of the coolant fluid medium to the immediate site of metal cutting by the replaceable cutter element of the machine tool;

It is another feature of the present invention to provide a novel machine tool such as a boring bar having a fluid flow passage extending longitudinally therethrough and supplying a flow of coolant fluid to a distribution passage system of the cutter support head of the machine tool, which is oriented for delivery of coolant fluid to the point of metal cutting of a replaceable metal cutting insert that is mounted to the head structure of the tool;

It is also a feature of the present invention to provide a novel machine tool such as a boring bar having a head structure to which a metal cutting insert is releasably fixed by a clamp assembly and with a clamp member of the clamp assembly defining a portion of a coolant fluid supply passage and having a coolant fluid distribution opening that is located to direct a jet of coolant fluid onto the metal cutting insert and at the immediate vicinity of metal cutting during a boring operation; and

It is an even further feature of the present invention to provide a novel boring bar assembly wherein a clamp is secured to a machine tool head by a clamp screw for supporting a replaceable metal cutting insert and wherein the clamp and clamp screw cooperate with the head structure of the machine tool to define one or more coolant fluid flow passages having at least one coolant fluid discharge opening on the clamp for directing one or more jets of coolant fluid to the immediate site of metal cutting.

Briefly, the various objects and features of the present invention are realized through the provision of a machine tool such as a boring bar having an elongate shank having an integral cutter support head structure at one end. A coolant fluid supply passage is defined in the cutter support head or extends longitudinally through the shank of the machine tool to the cutter support head and intersects a transverse coolant fluid flow passage which is defined in part by a clamp screw passage of the cutter support head. The clamp screw also defines a passage permitting the flow of coolant fluid from the coolant supply passage to the coolant distribution passage or passages of the cutter retaining clamp.

Alternatively, the coolant fluid flow passage can be provided only in the head portion of the tool, with a coolant supply line of the tool being connected to the tool head. In accordance with the preferred embodiment and best mode of the present invention, a coolant distribution nozzle is mounted to the head of the tool by a mounting bolt and the nozzle and its mounting bolt provide for coolant distribution to the metal cutting interface and also provide a clamping function for retaining a metal cutting insert in proper position on the tool head for optimum machining. Alternatively, a replaceable metal cutting insert is clamped to the cutter support head structure by a clamp member that is secured by a clamp screw being threaded into the clamp screw passage. The clamp screw, and its association with the cutter support head structure, cooperate to define an internal or external flow passage permitting fluid flow transition from the longitudinal boring bar flow passage and through the head and clamp structures.

The clamp member defines one or more internal coolant fluid flow passages that terminate at one or more discharge openings located on the clamp member. The discharge opening or openings are each located and oriented to direct a discharge or jet of coolant fluid onto the metal cutting insert immediately at the site of its metal cutting operation within the rotating work-piece. In the preferred embodiment of the invention the clamp screw defines an internal passage that is in communication with the transverse coolant fluid flow passage and conducts coolant fluid to the internal coolant fluid flow passage or passages of the clamp member for precise distribution of coolant flow to the metal cutting insert. In a further alternative embodiment of the invention, an annular clearance is defined about the shank of the clamp screw and which serves as a flow passage. This annular flow passage is in fluid communication with the internal coolant fluid discharge passage or passages of the clamp or coolant fluid distribution nozzle member. The coolant fluid distributing nozzle defines an internal coolant flow passage having an exit or discharge opening directed immediately at the site of metal cutting by the insert and thus maintains the metal cutting insert as cool as possible during boring operations. The coolant minimizes heat induced wear and deterioration of the metal cutting insert and thus enhances its service life.

The cutter support head of the machine tool holder of the present invention is also machined to provide a coolant fluid distribution passage and opening that directs a jet of coolant fluid in a manner for flushing away metal chips and preventing an accumulation of metal chips or cuttings that might otherwise interfere with the efficiency and accuracy of a metal cutting operation. The chip flushing coolant discharge opening of the cutter support head may be provided with a removable jet nozzle, thus permitting the character of the chip flushing jet of high pressure coolant to be changed simply by substituting a larger or smaller jet nozzle for a particular jet nozzle being used.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

### In the Drawings:

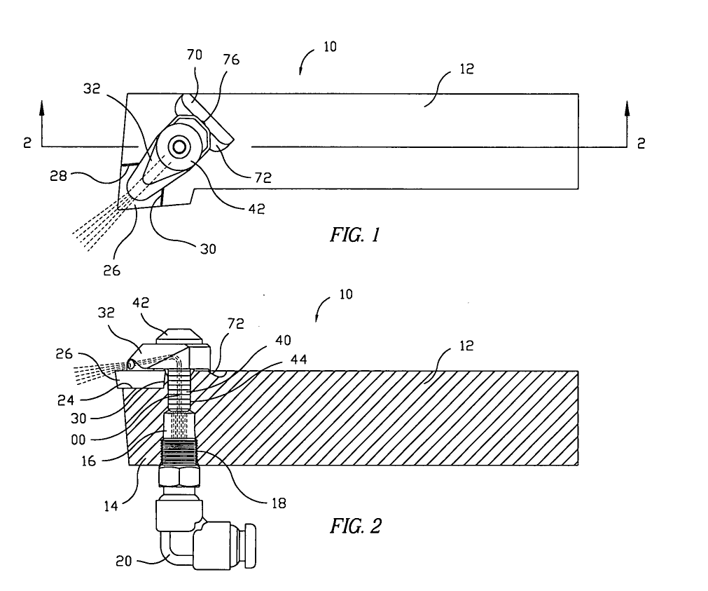

FIG. 1 is a plan view of a machine tool holder, such as a boring bar, having a coolant fluid supply passage therein according to the principles of the present invention, and representing the preferred embodiment of the present invention;

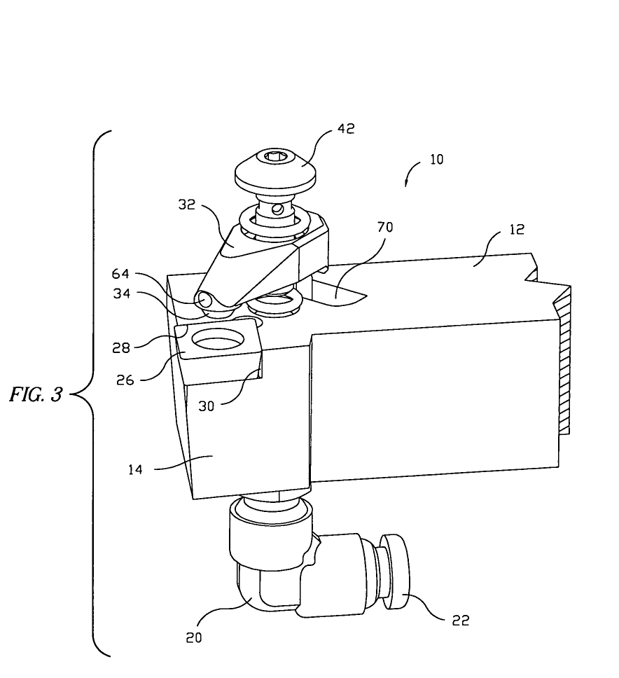

FIG. 2 is a longitudinal sectional view of the machine tool holder of FIG. 1, showing a swivel fitting for supply of coolant fluid, showing the coolant supply passage of the cutter support head and further showing a cutter retaining clamp and clamp retainer having a coolant fluid distribution passage directing a jet of coolant fluid to the cutting interface of a cutter insert;

FIG. 3 is a partial exploded isometric illustration showing the cutter support head portion of the machine tool holder of FIGS. 1 and 2, showing the relationship of the various components of the tool holder, coolant distributing clamp and cutter insert;

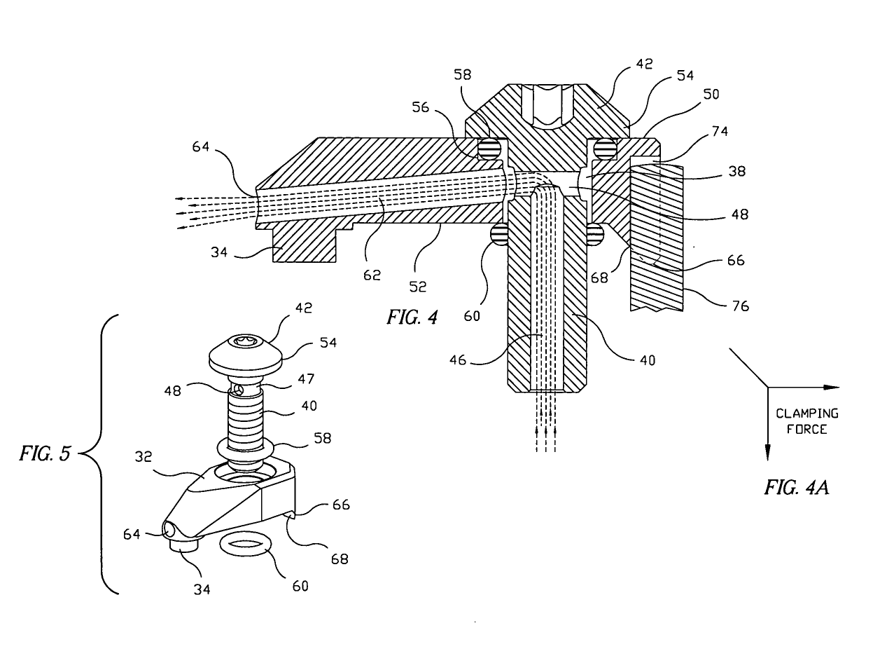

FIG. 4 is a sectional view taken along line 4-4 of FIG. 1, and showing an internal coolant flow passage that is cooperatively defined by a cutter retaining clamp and a clamp retaining fastener member and showing seals for sealing of the coolant fluid flow and distribution passages of the clamp retaining fastener member and cutter insert retaining clamp;

FIG. 4A is a diagrammatic illustration of the clamping and clamp and cutter insert positioning forces that are achieved upon tightening of the clamp retaining fastener member;

FIG. 5 is an exploded isometric illustration of the cutter retaining clamp and a clamp retaining fastener member and coolant fluid seals of FIG. 4;

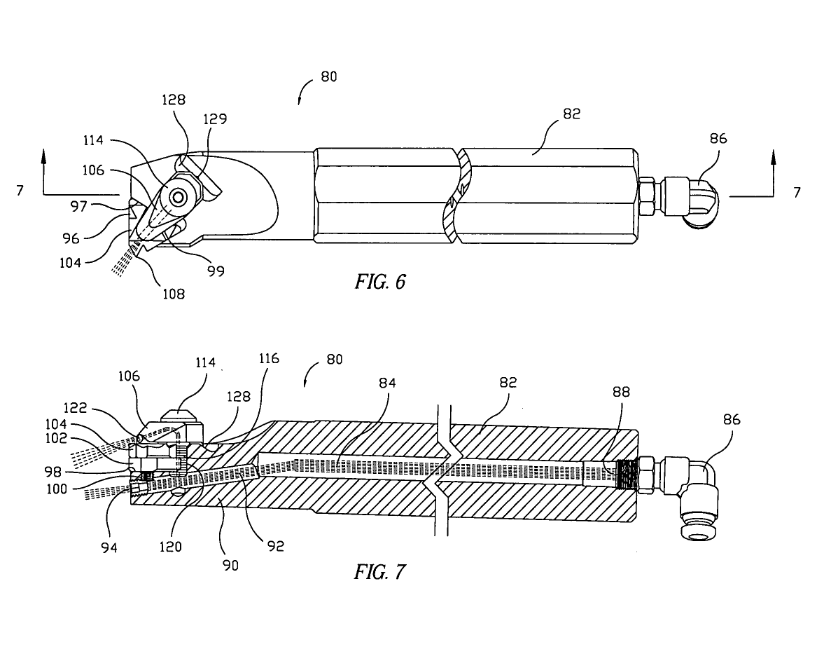

FIG. 6 is a plan view of the integral shank and cutter insert support head structure of a machine tool holder representing an alternative embodiment of the present invention wherein a coolant fluid supply passage extends longitudinally through the shank or bar of the machine tool and supplies coolant fluid to fluid distribution and chip removal passages in the cutter support head portion of the tool;

FIG. 7 is a longitudinal sectional view of the integral shank and head structure of the machine tool holder taken along line 7-7 of FIG. 6 and showing coolant fluid supply and distribution flow passages and further showing cutter insert positioning with respect to the cutter support head portion of the tool;

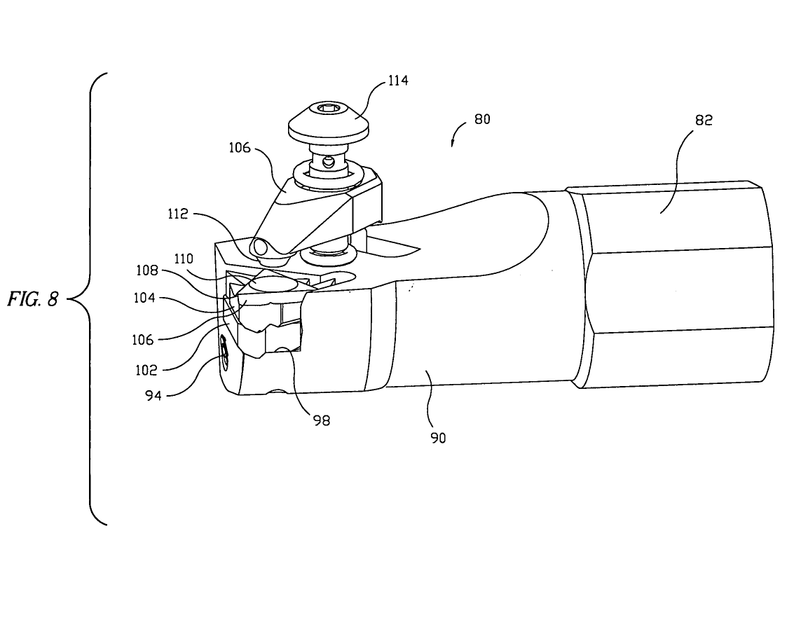

FIG. 8 is an exploded isometric illustration of view of the cutter support head portion of the tool the machine tool holder of FIGS. 6 and 7, showing cutter insert positioning with respect to a cutter support seat and cutter support and showing positioning of cooling and chip removal jets with respect to the structure of the cutter insert support head;

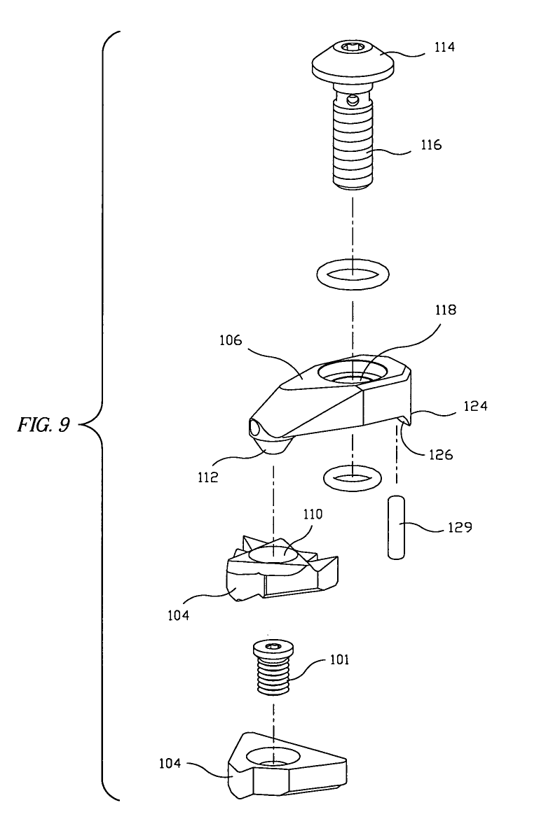

FIG. 9 is an exploded isometric illustration of the coolant fluid emitting clamp member, the clamp retainer member and the cutter insert and cutter insert support member of the machine tool holder embodiment of FIGS. 6-8;

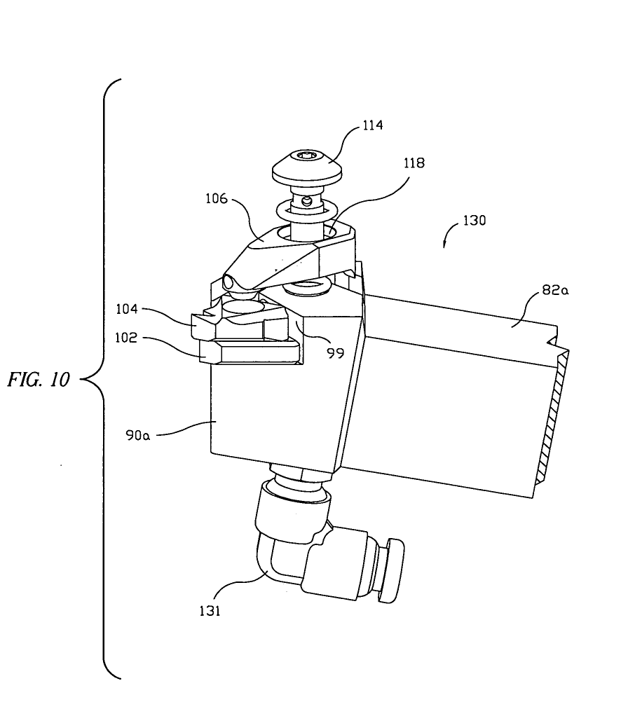

FIG. 10 is an exploded isometric illustration of the cutter support and coolant fluid distribution head portion of the machine tool of FIGS. 6-9;

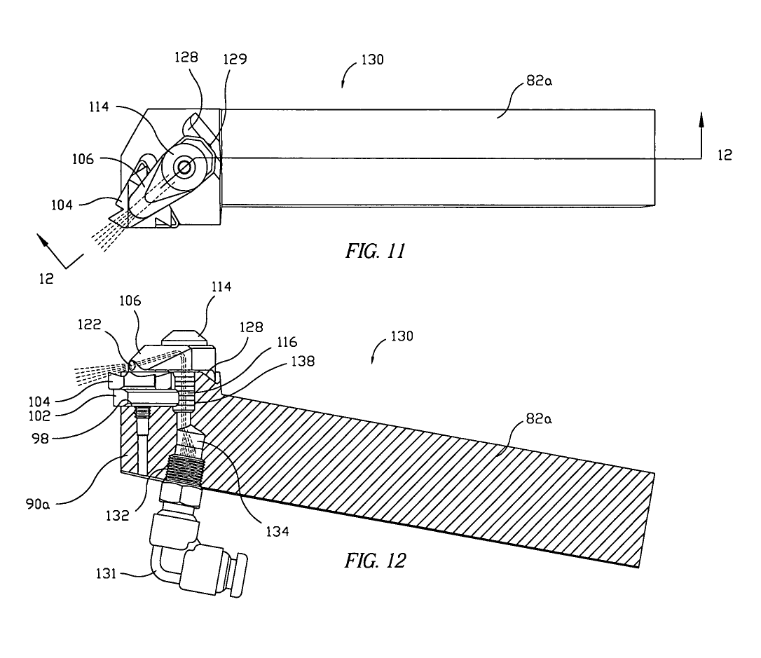

FIG. 11 is a plan view showing the machine tool holder of FIGS. 6-10, with the tool holder shank being of rectangular cross-sectional configuration and the coolant fluid supply being directly connected to the cutter support head;

FIG. 12 is a longitudinal sectional view taken along line 12-12 of FIG. 11;

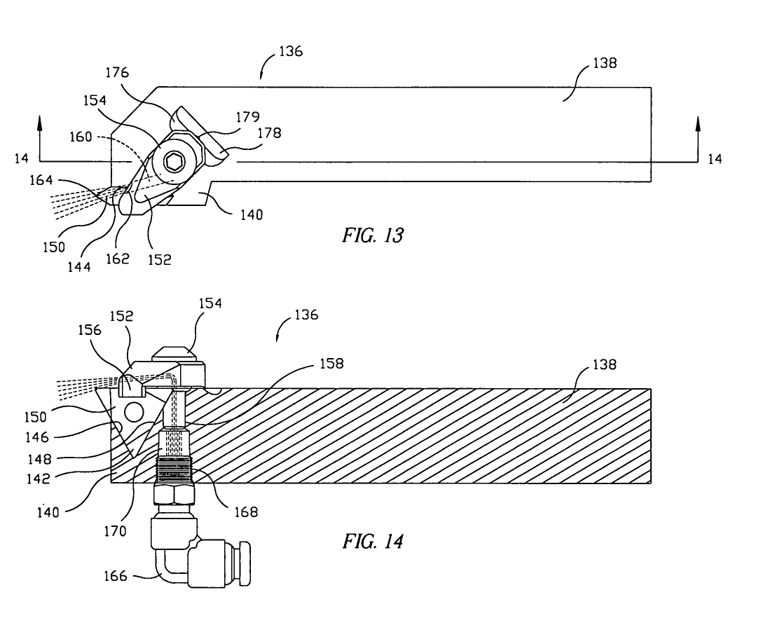

FIG. 13 is a plan view of a machine tool holder representing another embodiment of the present invention which is adapted for threading and grooving operations and which defines a cutter pocket for edgewise support of a cutter insert and which also includes a coolant fluid supply and distribution according to the principles of the present invention;

FIG. 14 is a longitudinal sectional view taken along line 14-14 of FIG. 13;

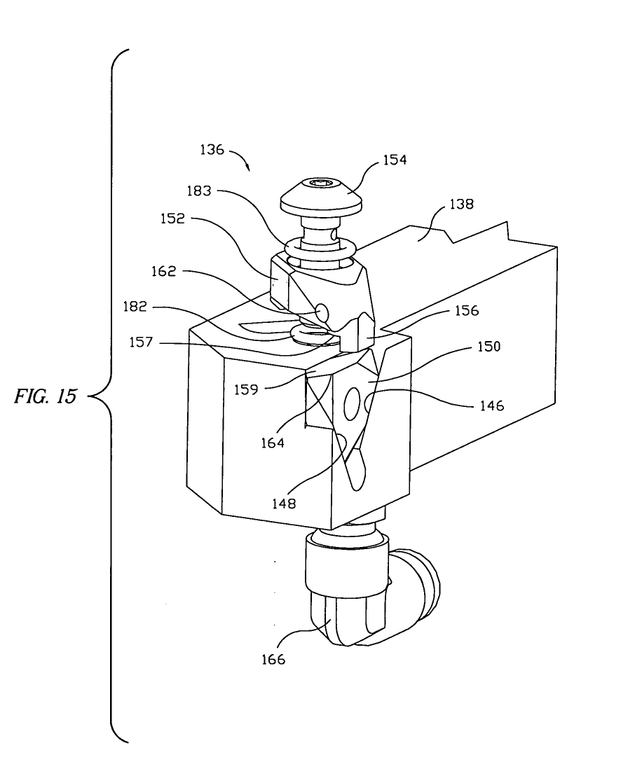

FIG. 15 is an exploded isometric illustration of the cutter support and coolant fluid distribution head portion of the machine tool holder of FIGS. 13 and 14;

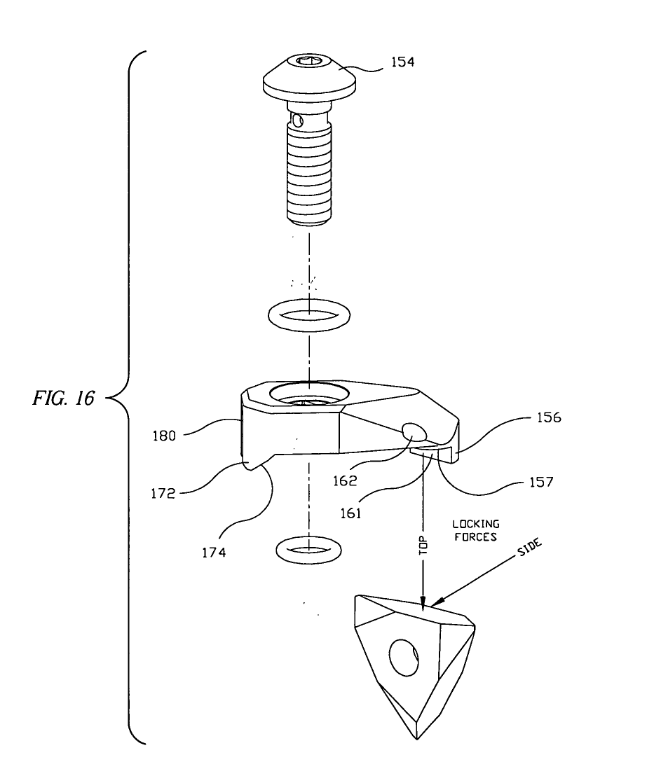

FIG. 16 is an exploded isometric illustration showing the cutter retaining clamp and clamp retainer screw member of FIGS. 13 and 14;

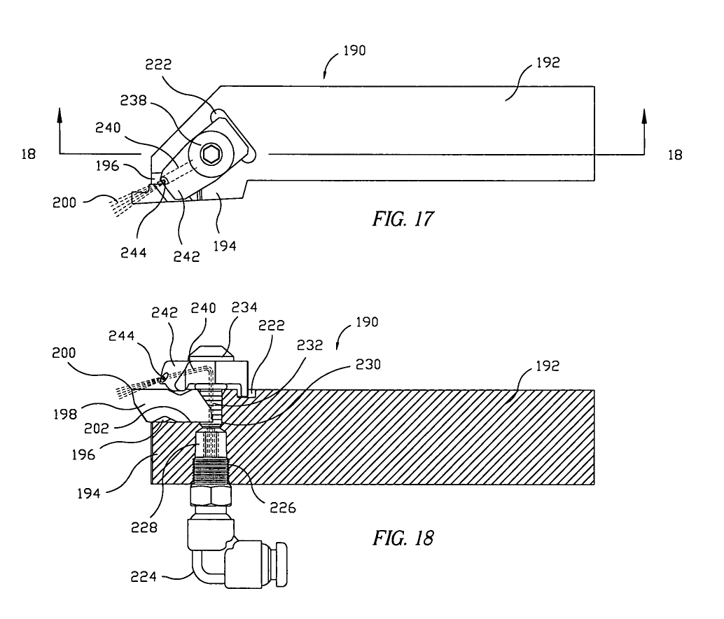

FIG. 17 is a plan view showing a machine tool holder for threading and notching or grooving operations and having a coolant fluid distribution system according to the teachings of the present invention;

FIG. 18 is a longitudinal sectional view taken along line 18-18 of the machine tool holder of FIG. 1;

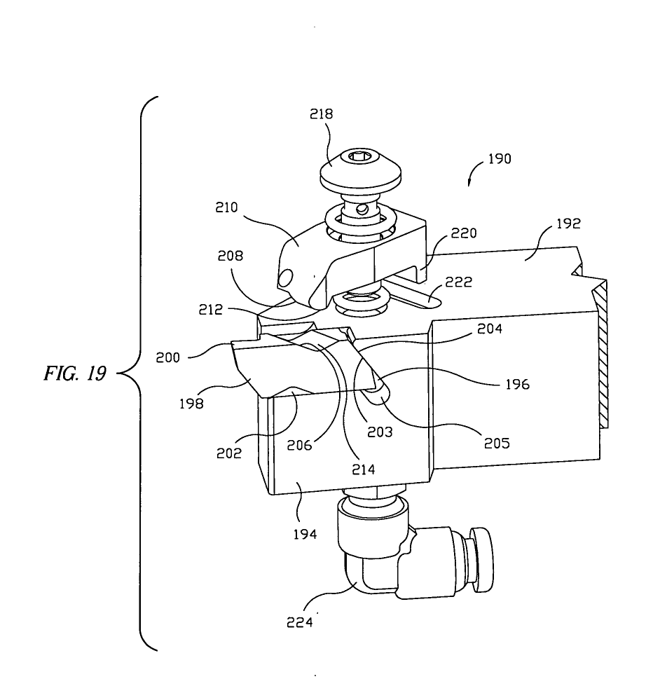

FIG. 19 is an exploded isometric illustration of the cutter support head portion of the machine tool holder of FIGS. 17 and 18;

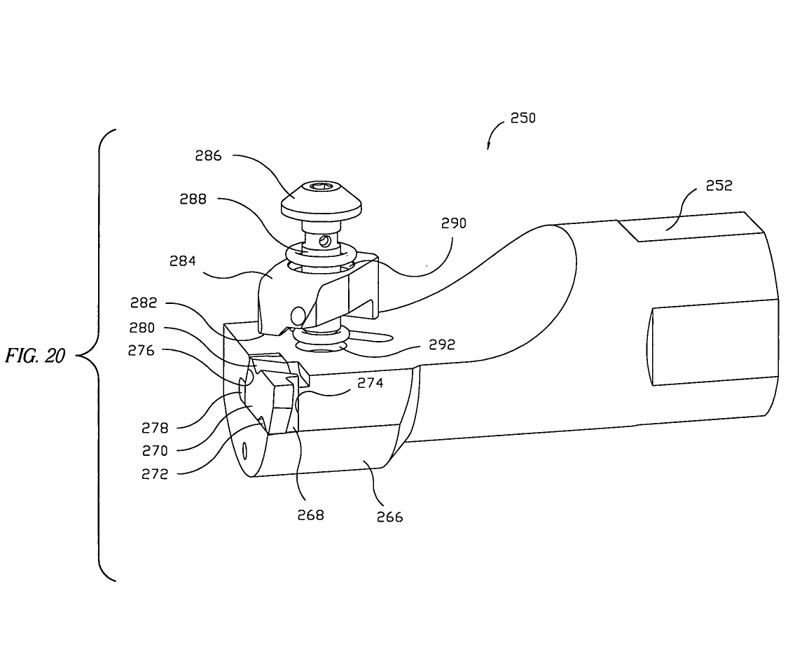

FIG. 20 is an exploded isometric illustration of a cutter insert tool holder with the head portion of the tool being substantially identical to the head structure of FIGS. 17-19 and with the shank of the tool holder being of generally octagonal cross-sectional configuration rather than rectangular cross-sectional configuration;

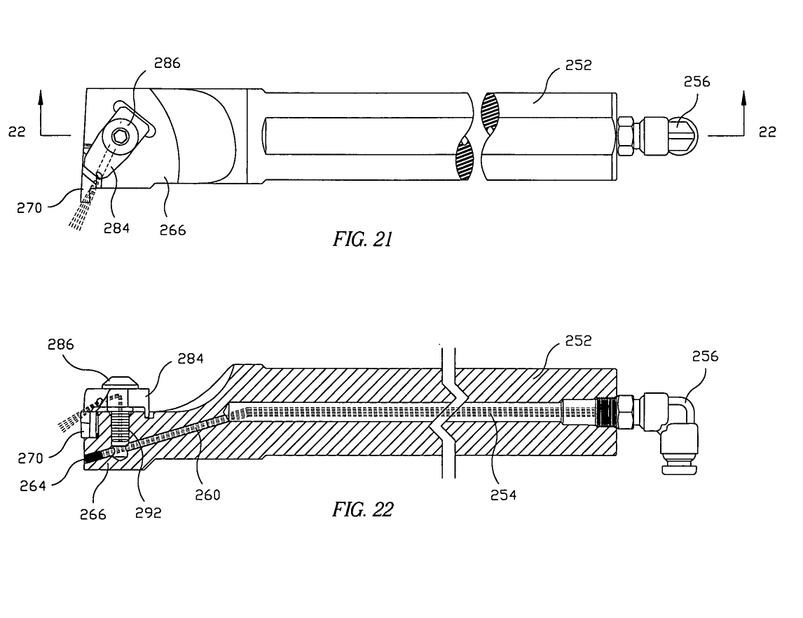

FIG. 21 is a plan view taken of the machine tool holder of FIG. 20 and having a length depending on the length of the workpiece being machined;

FIG. 22 is a longitudinal sectional view taken along line 22-22 of FIG. 21;

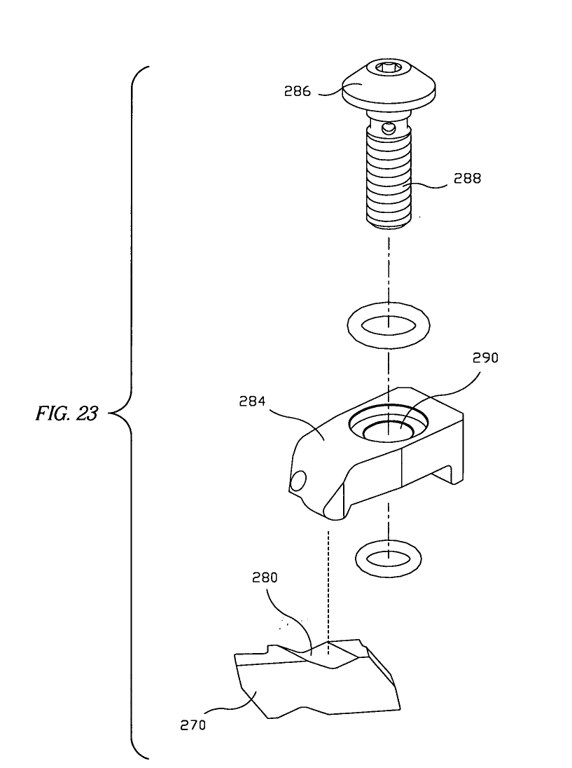

FIG. 23 is an exploded isometric illustration showing the cutter insert retaining clamp and clamp retaining screw of FIGS. 17-22;

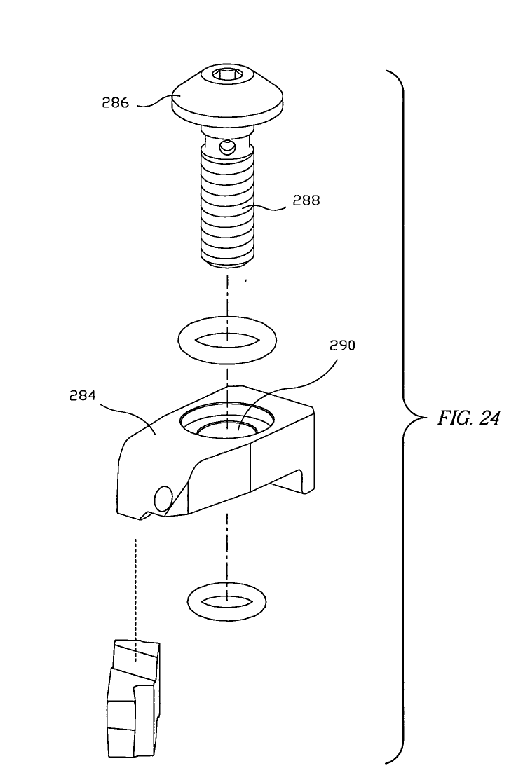

FIG. 24 is another exploded isometric illustration showing the cutter insert retaining clamp and clamp retaining screw of FIGS. 17-22 showing different cutter insert orientation as compared with the illustration of FIG. 23;

FIG. 25 is an isometric illustration of a boring bar assembly showing a tool holder with a boring bar in assembly therewith and having a sealing mechanism minimizing the potential for leakage of coolant fluid along the exterior flats of the boring bar;

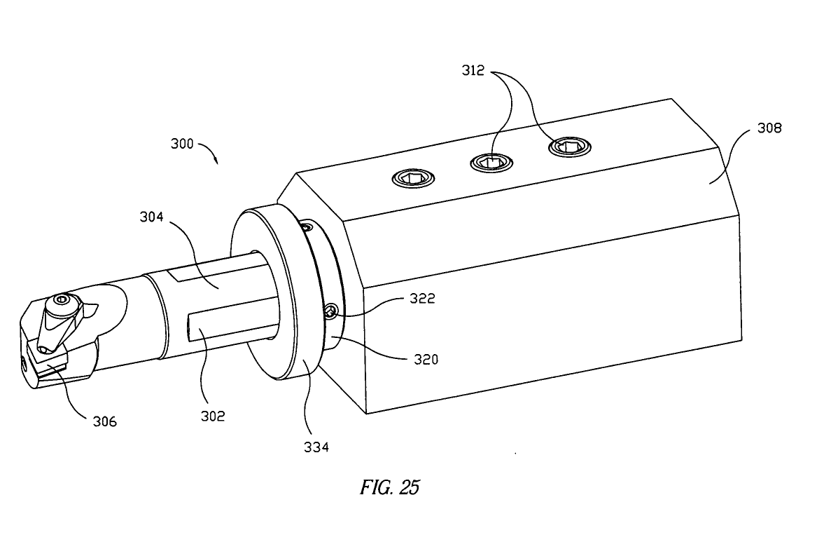

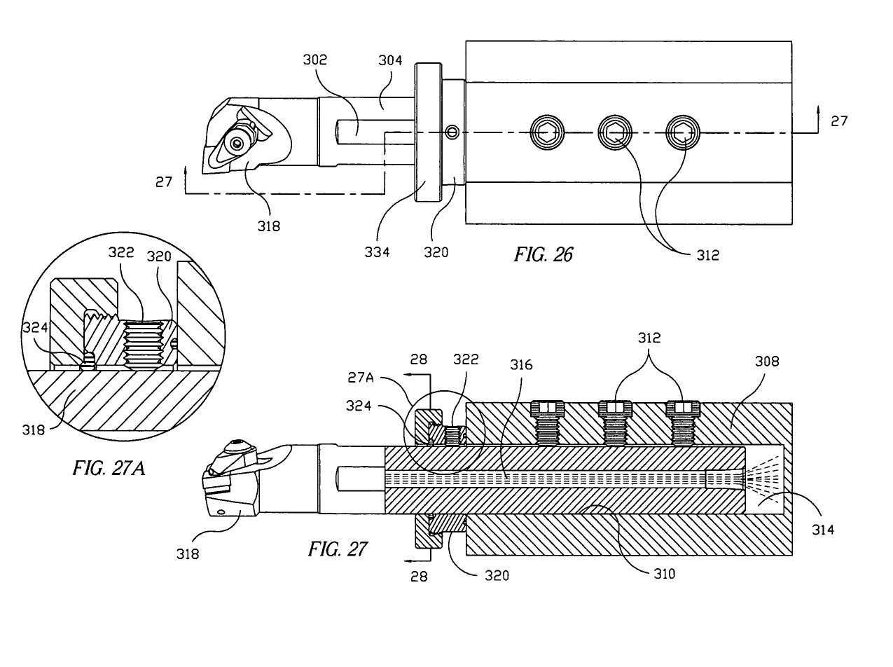

FIG. 26 is a plan view of the boring bar assembly of FIG. 25;

FIG. 27 is a longitudinal sectional view taken along line 27-27 of FIG. 26;

FIG. 28 is a transverse sectional view taken along line 28-28 of FIG. 27;

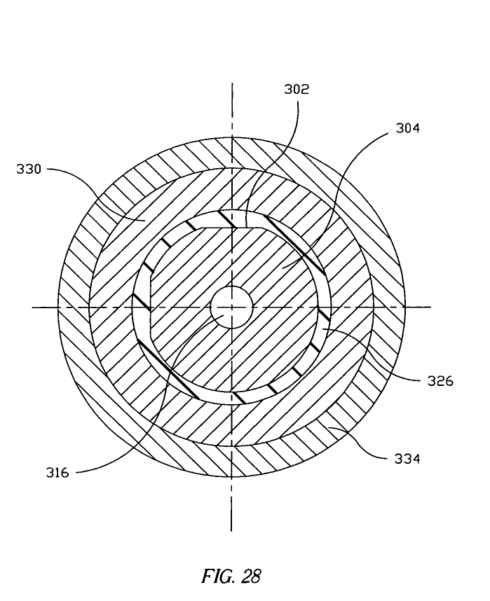

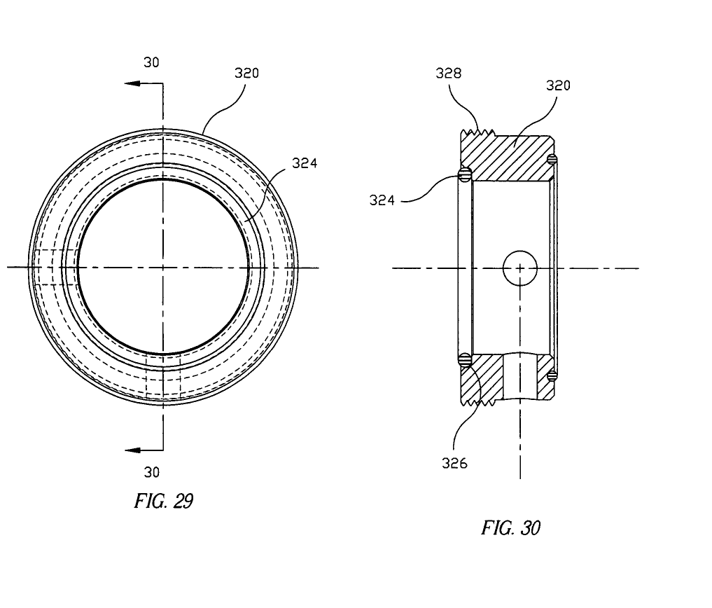

FIG. 29 is an elevational view of a coolant seal support member of the boring bar assembly of FIGS. 25-27;

FIG. 30 is a transverse sectional view taken along line 30-30 of FIG. 29;

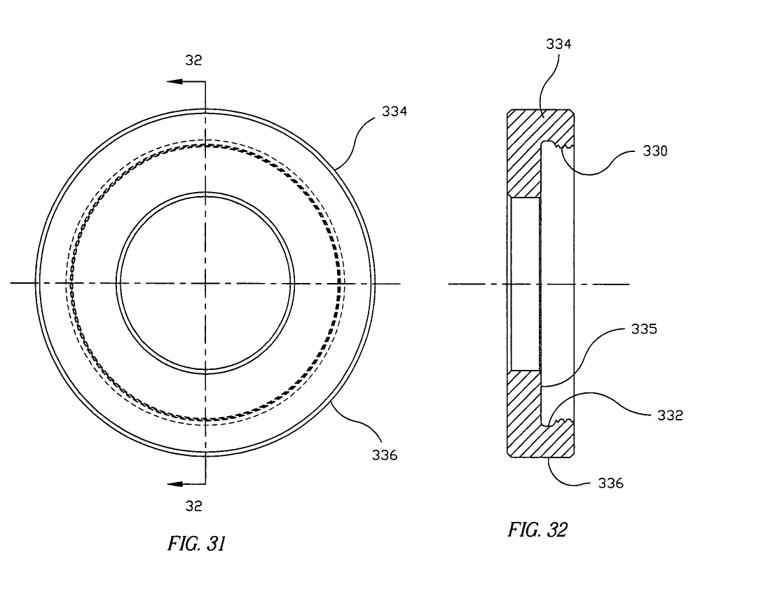

FIG. 31 is an elevational view of a coolant seal retainer member of the boring bar assembly of FIGS. 25-27; and

FIG. 32 is a sectional view taken along line 32-32 of FIG. 31.

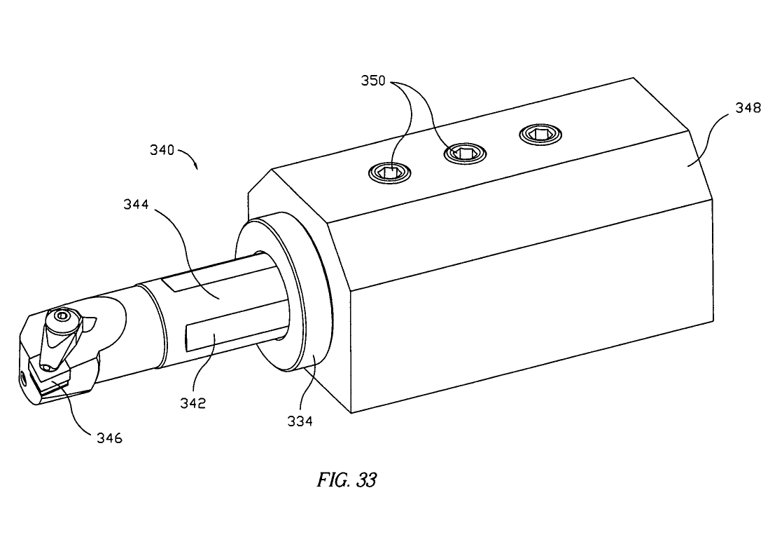

FIG. 33 is another isometric illustration showing a boring bar and tool holder assembly similar to that of FIG. 25;

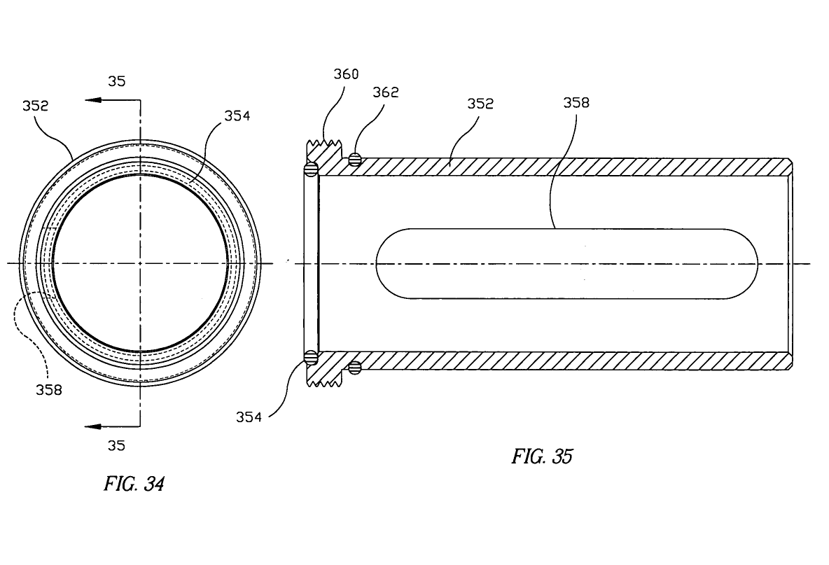

FIG. 34 is an end view of the reducer bushing of the boring bar assembly of FIG. 33;

FIG. 35 is a longitudinal sectional view taken along line 35-35 of FIG. 34;

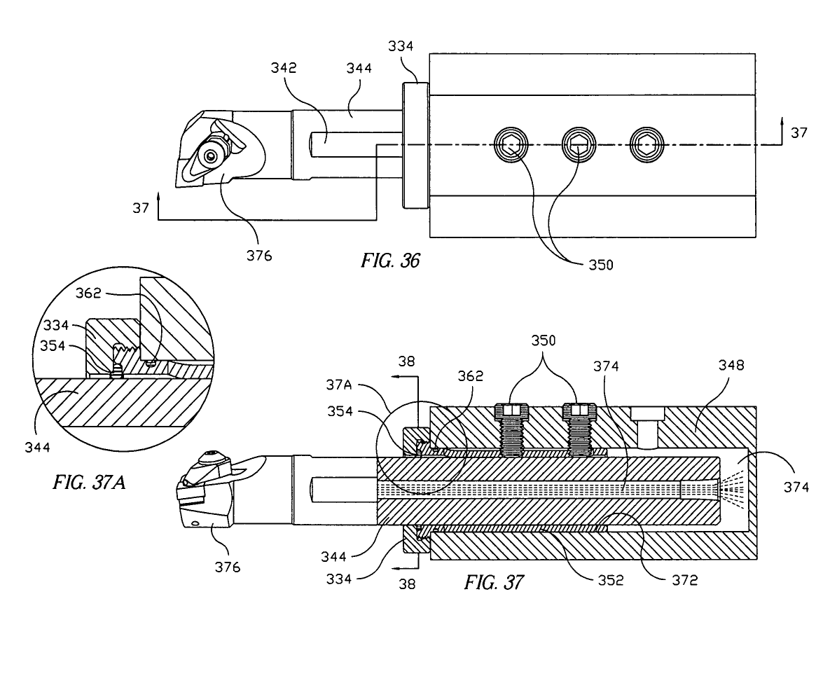

FIG. 36 is a plan view showing the boring bar and tool holder assembly of FIG. 33;

FIG. 37 is a longitudinal sectional view taken along line 37-37 of FIG. 36;

FIG. 37A is an enlarged fragmentary sectional view showing the encircled region of FIG. 37; and

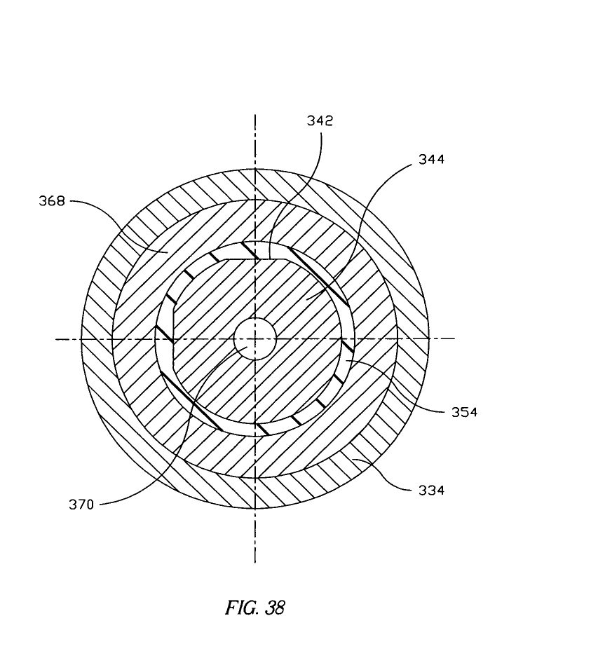

FIG. 38 is a transverse sectional view taken along line 38-38 of FIG. 37.

### DETAILED DESCRIPTION OF PREFERRED EMBODIMENT

For purposes of simplicity, the present invention is discussed herein particularly with respect to its form as a boring bar for cutting or boring operations on the interior of a work-piece being rotated by a metal working machine. However, it is to be understood that the present invention has application to a wide range of machine tool holders for external as well as internal machining operations; thus this specification is to be intended as descriptive of a wide range of cutter support machine tools and is not as intended as restricting the spirit and scope of the invention to boring bars or any other type of cutter supporting machine tools.

Referring now to the drawings and first to FIGS. 1-3 a coolant fluid supplying machine tool or cutter insert holder, such as a boring bar, is shown generally at 10, having an elongate tool shank 12 with cutter insert support head 14 at one end thereof and representing a preferred embodiment of the present invention. The cutter insert holder of FIGS. 1-3 is referred to as a JETSTREAM™ SCREW-LOCK™ (trademarks of Dorian Tool International) positive style square or rectangular shank tool holder The cutter insert support head 14 defines a coolant fluid supply passage 16 which in the embodiment of FIGS. 1 and 2 is internally threaded at 18 and threadedly receives a coolant supply fitting 20 such as the 90° swivel fitting that is shown in FIG. 2. The coolant supply fitting 20 is provided with a connector 22 adapting the fitting for connection with the corresponding quick-disconnect connector of a coolant supply hose (not shown).

The cutter insert support head 14 of the machine tool holder 10 defines a cutter insert seat 24 which provides stable support for a cutter insert member 26 which establishes a cutting interface with a workpiece being moved rotationally or linearly relative thereto depending upon the character of machining that is involved. The cutter insert member 26 is composed of hardened metal and defines a proper cutting edge rake angle for efficient machining of the workpiece. When the cutter insert member 26 becomes worn to the point that the efficiency of metal cutting becomes degraded the cutter insert member will be removed and replaced with a new cutter insert member.

Typically the cutter insert member 26 is provided with a central opening within which a retainer member such as a set screw is received and defines an internal shoulder or tapered surface that is engaged by a corresponding retainer portion of the set screw, thus positively securing the cutter insert member in immovable relation with respect to the cutter insert seat 24. The cutter insert seat is further defined by seat shoulders 28 and 30 of the head portion 14 which also function to stabilize the cutter insert member with respect to the head portion of the tool. The seat shoulders 28 and 30 may be slightly tapered or inclined at corresponding angles as compared with edge portion of the cutter insert member and the intersection of the shoulder surfaces is relieved as shown at 31 thus permitting the cutter insert member 26 to establish tight motion preventing engagement with the seat shoulders. This feature permits the cutter insert member to be firmly and immovably seated in the head portion of the tool and capable of withstanding extremely heavy cutting loads.

A clamp and coolant distribution member 32, best shown in FIGS. 3-5, is mounted to the head portion 14 and defines an insert retainer projection 34 that extends downwardly into a circular opening 36 of the cutter insert member 26. The clamp and coolant distribution member 32 defines a generally vertical passage 38 through which extends the threaded shank 40 of a clamp retainer screw 42. The threaded shank 40 is received by an internally threaded passage 44 of the head 14 and defines a central flow passage 46 through which coolant fluid flows from coolant fluid supply passage 16. The shank 40 of the clamp retainer screw 42 also defines a transverse flow passage 48 which intersects the central flow passage 46 also intersects a circular external groove 47 and provides for communication of the coolant medium with the generally vertical passage 38. Generally planar surfaces 50 and 52 and defined by the clamp member 32 for movement limiting engagement by the head portion 54 of the clamp retainer screw and for engagement by an annular seal member. A circular seal recess 56 is formed in the upper portion of the clamp member 32 and contains an annular, typically O-ring type resilient sealing member 58. The head portion 54 of the retainer screw 42 is sufficiently large to overlie the seal recess 56, to retain the resilient seal member 58 within the seal recess and to engage the upper surface 50 of the clamp member 32. The seal recess 56 is of such dimension, relative to the dimension of the seal member 58 that the seal member is maintained under sufficient compression to establish a positive seal between the clamp member and the head portion 54 of the retainer screw. If desired, a circular washer 59 may be interposed between the head of the retainer screw and the annular seal member 58.

As the retainer screw is tightened, it serves to cause compression of a lower annular typically O-ring type resilient seal 60 that is positioned around the shank of the retainer screw, thus establishing a seal between the clamp member and the shank 40 of the retainer screw to prevent leakage of the coolant fluid from the passage 38. The clamp and coolant distribution member 32 defines one or more coolant distribution passages 62 that intersect the generally vertical passage 38 and terminate at a coolant jet opening 64. The coolant jet opening or openings 64 is located in overlying relation with the upper portion of the metal cutting insert 26 and directs one or more jets of coolant fluid at the cutting interface of the metal cutting insert with a moving workpiece, thus efficiently cooling the cutting interface and significantly enhancing the service life of the metal cutting insert.

The clamp and coolant distribution member 32 also defines a depending projection 66 that is located at the rear portion of the clamp member and defines an angulated cam surface 68. When the clamp member 32 is tightened by forcible rotation of the retainer screw 42 the depending projection will enter a clamp recess 70 and will establish camming engagement with a corresponding angulated cam surface 72. As the angulated cam surfaces 68 and 72 interact during tightening of the clamp retainer screw 42 the clamp and coolant distribution member 32 is moved downwardly and rearwardly as shown by the clamping force distribution diagram of FIG. 4A. The downward and rearward force vectors evident from FIG. 4A cause the insert retainer projection 34 to apply downward and rearward clamping force to the metal cutting insert 26 thus ensuring that the metal cutting insert is retained in properly seated and supported immovable relation within the cutter insert seat 24. The rear portion of the clamp and coolant distribution member 32 also defines an orienting recess 74 within which is received an orienting pin 76 that is seated within a pin receptacle of the cutter insert support head 14. The orienting pin 76 is fitted tightly within the orienting recess 74 and serves to restrain the clamp and coolant distribution member 32 against potential rotation from its insert clamping position due to the forces of metal cutting operations. The combined effects of the clamp member 32, the angulated cam surfaces 68 and 72 and the orienting pin 76 cause the metal cutting insert to be positively locked within its seat and prevent any movement, vibration or chattering of the insert during the machining process.

As disclosed in FIGS. 6-12, an alternative embodiment of the present invention is referred to as a JETSTREAM™, LAY-DOWN™ style threading bar, shown generally at 80, having a threading insert clamping mechanism that also provides for coolant and chip removal flow through the clamping mechanism to provide jets of coolant fluid that are precisely directed to the threading interface and chip accumulation region of the threading tool. As shown in FIGS. 6 and 7, the threading bar 80 has an elongate shank 82 which is shown with an intermediate break since the shank can be of any desired length that is suitable for the threading operation that is to be conducted. A coolant supply passage 84 extends longitudinally through the shank 82 and a suitable coolant supply fitting, such as the swivel fitting 86, is threaded into an internally threaded portion 88 of the coolant supply passage. A coolant supply hose, not shown, is connected with the swivel fitting, typically by means of a quick-disconnect connector, to conduct coolant fluid from the coolant pump of the machining system. The threading bar 80 is typically of octagonal external configuration though it may have any other suitable configuration as well. A cutter support head 90 is integral with the elongate shank 82 and is provided with an internal coolant fluid distribution passage 92 that is typically defined by a drilled bore which intersects the coolant supply passage 84. A chip flush nozzle 94 is threaded into an internally threaded outer portion of the coolant fluid distribution passage 92. The chip flush nozzle defines an orifice from which a flushing jet of coolant fluid as a flushing medium is emitted, the jet being oriented to the machining region at which metal chips or cuttings are likely to undesirably accumulate during the threading or machining process. The flushing jet of coolant fluid is of proper dimension and force to dislodge accumulated metal chips or cuttings and to flush them away from the machining interface. When different machining operations, such as heavy cuts or light cuts are being accomplished, it may be desirable to unthread the chip flush nozzle from its threaded receptacle and replace it will a chip flush nozzle having an orifice of different dimension.

The cutter support head 90 defines a cutter insert seat recess 96, which in the case of threading bars is of generally triangular configuration and defines a seat surface 98. Seat shoulders 97 and 99 also define portions of the cutter insert seat recess and establish orientation and support for a threading or other metal cutting insert. An internally threaded hole 100 is also defined by the cutter support head 90 and receives a set screw or other suitable retainer member 101 which is employed to secure a cutter seat member 102 in fixed relation with the seat surface 98. A threading or thread cutting insert 104 or other suitable machining insert is positioned on the cutter seat member 102 and is clamped in place by a clamp member 106. The thread cutting insert 104 defines a thread cutting portion 106 having a thread cutting point 108 and having a desire rake angle for the optimum cutting of internal or external threads in a rotating workpiece. The thread cutting insert 104 defines a generally circular opening 110 within which is received a depending locking projection 112 that is integral with and extends downwardly from the clamp and coolant fluid distribution member 106. The depending locking projection 112 may be of tapered configuration as shown particularly in FIGS. 8 and 9 and may fit within a correspondingly tapered opening of the threading insert member thereby ensuring that the threading insert is positively locket at its optimum thread cutting position with respect to the head portion 90 of the threading bar. The geometry of the threading insert recess 96 and the geometry of the seat member 102 and the interfitting relation of the depending locking projection 112 within the insert opening 110 function in concert to prevent rotation of the threading insert relative to the seat recess and to prevent vibration or chattering of the threading insert as a threading operation is being accomplished. Stabilization and orientation of the seat member 102 and threading insert 104 is also enhanced by the seat recess shoulders 97 and 99.

The clamp and coolant fluid distribution member 106 is of substantially the same construction and purpose as compared with the clamp and coolant fluid distribution member 32 of FIGS. 1-5. The clamp member is forcibly retained to the head portion 90 of the threading bar 80 by a clamp retainer screw 114 having an externally threaded screw shank 116 that extends through a passage 118 of the clamp member and is received in threaded engagement within a threaded bore 120 that is defined within the cutter support head 90. The clamp retainer screw 114 has an internal longitudinal passage such as is shown and described at 46 in FIG. 4 and a transverse passage and circumferential groove as shown at 47 and 48 in FIGS. 4 and 5. The clamp and coolant fluid distribution member 106 further defines an internal coolant distribution passage, such as is shown at 62 in FIG. 4, which terminates at a coolant jet opening 122 that is of a suitable dimension and orientation to project a jet of coolant fluid directly onto the metal cutting interface of the threading insert 104 with a rotating workpiece. If a smaller or larger jet opening is needed, it is a simple process to remove the clamp member 106 and replace it with a jet opening of desired dimension and orientation. Also, if desired the clamp member may be provided with a removeable and replaceable jet nozzle that is threaded into an internally threaded outlet portion of the coolant distribution passage, thus providing a simple and efficient means for changing the coolant jet application to the cutting or threading interface of the threading or cutting insert without necessitating removal of the clamp member.

The downward and rearward force vector application exemplified by the force vector diagram of FIG. 4A is achieved by the clamp and clamp retainer screw members in the manner discussed above. The clamp and coolant fluid distribution member 106, as shown in the exploded view of FIG. 9 and in FIGS. 10-12, is provided with a depending locking projection 124 having a tapered cam surface 126. As the clamp member is forced downwardly by tightening its clamp retainer screw 114 the tapered cam surface 126 reacts with a correspondingly tapered surface 128, best shown in FIG. 12, and applies downward and rearward forces to the clamp member. These downward and rearward forces are represented by the force vectors shown in the vector diagram of FIG. 4A and are transferred via the clamp member 106 to the threading or other metal cutting insert 104. In this manner the threading or other metal cutting insert 104 is positively secured in firmly seated relation within the seat 96 and in supported relation with seat shoulder surfaces 97 and 99. The clamp member is further oriented and stabilized by means of a clamp orienting pin 129.

With reference to FIG. 10, a threading bar embodying the principles of the present invention and shown generally at 130 may also have a square or rectangular shank 82a which may have an internal longitudinal coolant supply passage and coolant supply fitting similar to that shown at 84 in FIG. 7. However, as shown in FIGS. 10 and 12, a coolant fluid supply fitting 131, such as a swivel fitting, is threaded into an internally threaded outer portion 132 of a coolant fluid supply passage 134 that is drilled or otherwise formed only in the cutter support head portion 90a. The coolant fluid supply passage 134 is in fluid communication with the internally threaded bore 120 into which the threaded shank portion 116 of the clamp retainer screw 114 is received. The threading insert clamp and clamp retainer screw are of essentially identical configuration and function as described above in connection with FIGS. 1-5. Though the coolant fluid flow passage through the clamp retainer screw is shown to be defined by an internal longitudinal bore which intersects a transverse passage, it should be borne in mind that this particular clamp retainer screw construction is not intended to limit the spirit and scope of the present invention in any manner whatever. If desired, the threaded shank of the clamp retainer screw may define an external groove or the threaded bore 120 may define an internal groove which functions as a coolant flow passage. It is only necessary that the clamp and coolant distribution member 106 be sealed to the threading insert support head 90a of the threading bar or other machine tool 130 and that the retainer screw be sealed to the clamp and coolant distribution member to prevent leakage of the coolant fluid at these mechanical joints. The elongate configuration of the threading insert clamp member 106 provides for location of the coolant fluid jet orifice or nozzle 122 in overlying relation with the threading or metal cutting insert 104 and position for directing a jet of coolant fluid directly onto the cutting interface of the threading or metal cutting insert with a rotating or otherwise moving workpiece. This feature causes efficient cooling of the threading or other metal cutting interface and thereby significantly extends the service life of the insert. And, as explained above, the volume, velocity or other character of the jet of coolant fluid may be selectively changed simply by replacing the clamp member with another clamp having different nozzle or orifice characteristics.

A further embodiment of the present invention is shown generally at 136 of FIGS. 13-16 wherein a threading or cutting insert holding tool, referred to as a JET-STREAM™ ON-EDGE™ threading and grooving bar or tool, and embodying the principles of the present invention, is shown to support a threading or grooving metal cutting insert positioned on its edge rather than being horizontally positioned and supported as shown in FIGS. 1-12. The threading or cutting insert holding tool 136 is shown to have an elongate shank 138 of square or rectangular cross-sectional configuration and with a cutting insert support and coolant fluid distribution head structure 140 that is integral with the shank. A generally triangular cutter insert seat 142 is formed in a side portion of the insert support and coolant fluid distribution head structure 140 and is defined in part by insert support surfaces 144, 146 and 148 which stabilize a threading or grooving cutter insert 150. A cutter retaining and coolant fluid distribution clamp member 152 is retained in clamping position on the cutting insert support and coolant fluid distribution head structure 140 by means of a clamp retaining screw 154. An insert retaining projection 156 extends downward from a front portion of the clamp 152 and is positioned to establish retaining or locking engagement with the cutter insert and to ensure that the cutter insert is retained within its seat during machining operations. The insert retaining projection 156 defines a downwardly facing support shoulder surface 157 that is disposed for retaining engagement with a top surface 159 of the threading or grooving insert. The clamping force of the clamp member is applied to the top surface 159 and thus prevents the insert 150 from being moved upwardly within its cutter recess by machining forces. The insert retaining projection 156 also defines a side support surface 161 which applies a side locking force to the threading or grooving insert to further restrain the insert within its seat recess. The clamp and its insert retaining projection 156 function to provide efficient stabilized support for the cutter insert even during the initial heavy-cut machining that is typically employed in production facilities.

For the purpose of directing one or more jets of coolant fluid precisely at the threading or grooving interface of the cutter insert with the workpiece during machining operations the clamp retainer screw 154 defines a threaded shank, such as is shown at 40 in FIG. 2 and at 116 in FIG. 7, which is threaded into an internally threaded bore 158. The clamp retainer screw 154 may be identical with the clamp retainer screws 42 and 114 which are described above. The clamp member 152 defines an internal coolant fluid distribution passage shown in broken line at 160 which terminates at a jet orifice or nozzle 162 that is located on a side portion of the clamp member 152 and is oriented to direct a jet of coolant fluid directly onto the threading or grooving point or edge 164 of the insert. In the event that additional or less flow of coolant fluid is desired for a particular aspect of the machining operation it is a simple process to remove the clamp and coolant fluid distribution member 152 and replace it with a different clamp and coolant fluid distribution member having a jet orifice or nozzle of a different dimension and configuration. Coolant fluid supply to the clamp and coolant fluid distribution clamp member is provided by a coolant fluid supply fitting 166 which is threaded into an internally threaded portion 168 of a coolant fluid supply passage 170 of the head structure 140 and to the internal longitudinal and transverse coolant flow passages of the clamp retainer screw 154.

The clamp and coolant fluid distribution member 152 defines a depending locking projection 172 having a tapered cam surface 174 that is disposed for camming engagement with a corresponding tapered surface 176 that forms a surface of a locking recess 178. During tightening rotation of the clamp retainer screw 154 the tapered cam surface 174 establishes camming engagement with the corresponding tapered surface 176 and develops downward and rearward forces on the clamp member that urge the threading or grooving insert tightly into its recess. This feature significantly minimizes the potential for any movement of the threading or grooving insert relative to the cutter support head portion 140 of the cutter insert holding tool 136. To further stabilize the clamp member 152 during machining operations and to ensure precisely oriented positioning of the clamp member relative to the cutter support head 140 the rear portion of the clamp member defines an orienting pin recess 180 within which is received an orienting and anti-rotation pin 179 which is of the same configuration and function as the orienting pins shown at 76 in FIG. 4 and 129 in FIG. 9. The orienting and anti-rotation pin 179 is also received within a pin receptacle of the cutter support head portion 140 to ensure against any rotation of the clamp member relative to the cutter support head.

As shown in the exploded isometric illustration of FIG. 15, sealing of the clamp member to the cutter support head portion 140 may be accomplished by an O-ring type resilient seal 182 which becomes compressed as the clamp member is tightened. Sealing of the retainer screw 154 to the clamp member 152 may be achieved by a resilient sealing washer 184 which may be backed up by a metal washer 186 orienting and. Preferably, however, the sealing arrangement will take the form shown in FIG. 4 where resilient O-ring seals such as shown at 58 and 60 are mechanically compressed between metal components to establish sufficient sealing capability to withstand the pressure range of the flowing coolant fluid.

With reference to FIGS. 17-24 a metal cutting insert holding tool is shown generally at 190 and is typically described as a JETSTREAM™, DOR-NOTCH™ threading and grooving tool. The threading and grooving tool 190 is composed of a square or rectangular tool shank 192 having an integral threading or grooving insert support head 194. The threading or grooving insert support head is machined to define a cutter recess 196 within which is received a threading or grooving insert 198 having a cutting edge 200 for metal cutting engagement with a rotating or other moving workpiece. The cutter recess 196 defines an upwardly facing support surface 202 on which the insert 198 is supported and defines an angulated support shoulder 203 which serves to capture and provide rearward support for an angulated rearward surface 204 of the insert 198. At the juncture of the surfaces 202 and 203 there is provided a relief region 205 which provides for complete seating of the insert on the surfaces 202 and 203 without causing interference with an opposite cutting edge of the insert The threading or grooving insert 198 also defines an angulated retainer groove 206, best shown in FIG. 19 which is engaged by a downwardly projecting locking portion 208 of a cutter retaining and coolant fluid distribution clamp member 210.

The downwardly projecting locking portion 208 defines a curved or tapered surface 212 which is disposed for force transmitting engagement with an inclined or curved surface 214 of the angulated retainer groove 206 such that when clamping force is applied to the insert by the clamp member 210 downward and rearward resultant forces are transmitted to the insert 198 and serve to force the insert tightly against the insert surfaces 202 and 203. These downward and rearward forces are defined by the force vector diagram of FIG. 4A and are developed as a clamp retainer screw 216 is tightened such as by means of an Allen or Torx wrench which engages within a wrench receptacle 218. If desired the angulated retainer groove 206 and the downwardly projecting locking portion 208 may have essentially identical configurations, thus causing the insert to be firmly clamped within its seat 196 as the clamp retainer screw is tightened. The clamp and coolant distribution member 210 is provided with a downwardly extending rear projection 220 which is received within a groove 222 that is formed in the upper surface portion of the cutter insert supporting head 194. As the clamp and its downwardly extending projection 220 are driven downwardly by the force of the clamp retainer screw 216, the curved or tapered surface 212 reacts with the tapered surface 206 of the insert 198 and causes application of downward and rearward forces to the clamp member 210 and thus causes downward and rearward force to be applied to the threading or grooving insert 198, further developing forces on the insert to secure it firmly within the insert recess and prevent its movement, vibration or chattering as machining operations progress.

For cooling of the machining interface of the cutting edge of the insert member 198 with the rotating workpiece a coolant fluid supply fitting 224 is threaded into an internally threaded outer portion 226 of a coolant supply passage 228 and is adapted to receive a coolant fluid supply hose, not shown, that extends from the discharge of a coolant pump of a metal working machine. The coolant supply passage 228 is in fluid communication with an internally threaded bore 230 in which the externally threaded shank 232 of a clamp retainer screw 234 is threaded. The clamp retainer screw 234 is preferably of similar construction and function as compared with the clamp retainer screw 42 of FIG. 4 and defines longitudinal and transverse coolant fluid flow passages that transfer flowing coolant fluid from the coolant fluid supply passage 228 to one or more coolant fluid distribution passages 240 as shown in broken line in FIG. 17 which are defined within an insert clamp and coolant distribution clamp member 242. The discharge terminus of the coolant fluid distribution passage 240 defines a coolant jet nozzle or orifice 244 which is located in overlying relation with the cutting insert and is positioned very close to the cutting interface. The jet nozzle is oriented to direct a jet of coolant fluid directly at the machining or cutting interface of the cutting edge 200 of the threading or grooving insert 198 with a rotating workpiece and thus causes continuous and efficient cooling of the cutting interface during machining.

Referring now to FIG. 20 a threading and grooving bar is shown generally at 250 and is referred to as a JETSTREAM™, DOR-NOTCH™ boring bar. The boring and grooving bar 250 comprises an elongate shank 252 which is shown to be of octagonal cross-sectional configuration, but may have any other suitable configuration within the spirit and scope of the present invention. The elongage shank 252 is drilled or otherwise machined to define an internal longitudinal coolant fluid supply passage 254 and a coolant supply fitting 256 is threaded into an internally threaded outer end 258 of the coolant fluid supply passage 254. The fitting 256 is adapted for releasable connection with a coolant fluid supply hose, not shown, that extends from the discharge of a coolant fluid pump with which a metal working machine is provided. The longitudinal coolant fluid supply passage 254 is in communication with another drilled bore 260 which extends into a cutting insert support head structure 262 which is integral with the elongate shank 252. The outer extent of the drilled bore 260 is provided with a removeable chip removal nozzle 264 from which coolant fluid is projected to a region adjacent the metal cutting insert as a jet of sufficient velocity and volume to continuously remove the typical accumulation of metal cuttings or chips that often accumulate. If not removed, this accumulation of metal chips can interfere with a machining process. The chip removal nozzle is typically threaded into the outer extent of the drilled bore 260 and thus is easily unthreaded, removed and replaced with a different nozzle having an orifice of differing size and geometry for the character of chip removal that is needed.

The threading and grooving bar 250 includes an integral cutter insert support head 266 which defines a cutter insert recess 268 within which a threading or grooving insert member 270 is seated. The cutter insert recess 268 defines bottom, side and end support shoulder surfaces, 272, 274 and 276 respectively, which provide for support and stabilization of the threading or grooving insert 270. The insert recess also defines a relief region 278 to permit the threading or grooving insert to be positively seated on each of the support shoulder surfaces. The insert 270, like the insert 198 of FIGS. 17-19 defines transverse grooves such as shown at 280, one of which is engaged by a depending projection 282 of a clamp and coolant distribution member 284. The configuration of the transverse groove and the configuration of the depending projection 282 function cooperatively to cause the threading or grooving insert to be forced into fully seated and supported relationship with the insert recess surfaces in the same manner as discussed above in connection with FIGS. 17-19.

The clamp member 284 is secured in insert retaining relation with the insert support head 254 by means of a clamp retainer screw 286 which defines a threaded screw shank 288 that extends through a passage 290 of the clamp member 284 and is received by an internally threaded passage 292 of the insert support head. The clamp retainer screw 286 defines longitudinal and transverse flow passages, such as shown in FIG. 4, for conducting flowing coolant fluid from the passage that is defined by the drilled bore 260 The clamp member 284 to an internal coolant fluid distribution passage 294.

As depicted by the isometric illustration of FIG. 25, a coolant fluid seal assembly shown generally at 300 is employed to minimize the potential for leakage of coolant fluid along the exterior flats 302 of a boring bar 304 or other fluid transporting tool holder mechanism for replaceable cutter inserts 306. A tool holder 308 of a machining system defines an internal tool receptacle 310 within which a boring bar or other machine tool is received as shown in FIG. 27. Retainer screws 312 are employed in conventional manner to secure the boring bar within the tool receptacle. During machining operations coolant fluid is pumped into a tool receptacle space 314 and traverses a longitudinal coolant fluid flow passage 316 of the boring bar to internal fluid passages of the cutter insert support head 318 and to the cooling and chip removal jets as explained above.

When the boring bar or other cutter support tool has external flats for efficiency of tool support and orientation, which is often the case, coolant fluid may have a tendency to leak along the longitudinal space that is defined by the clearance of the flats of the cutter support tool with the circular internal surface of the machine tool receptacle. To seal this potential for coolant fluid leakage, a seal support member 320 is positioned about the machine tool and is secured in place by one or more set screws 322 or any other suitable retainer member. The seal support member 320 defines a circular seal pocket 324 within which is received a circular seal member 326 composed of deformable resilient sealing material, such as rubber, soft polymer material or the like which is resistant to deterioration by contact with the coolant fluid medium. The seal support member 320 defines an external threaded section 328 which is received within an internally threaded section 330 that defines a portion of a circular seal retainer pocket 332 of a seal retainer member 334. The seal retainer member defines a planar circular retainer shoulder 335 that provides adequate support for the annular seal member and permits substantial mechanical deformation of the seal member as it is deformed to the configuration of the internal clearances. If desired, the external surface 336 of the seal retainer member 334 may be knurled or otherwise roughened to permit its manual tightening on the annular seal support member 330. Also, if desired, the seal retainer member may be secured in place by means of one or more set screws if desired. Generally, however, manual tightening is sufficient to deform the seal member and secure the seal retainer in place, since the resilient seal develops frictional resistance to minimize undesired rotation of the seal retainer due to the vibration of machining operations.

The annular seal member 326 has significant cross-sectional dimension thus enabling it to be mechanically deformed to the configuration shown in FIG. 28 so that it essentially fills the clearance that is defined by the flats and any circular clearance of the boring bar and develops a fluid tight seal that withstands the pressure of the coolant fluid

Referring now to FIGS. 33-38 a tool and tool holder assembly similar to that of FIG. 25 is shown generally at 340, wherein a boring bar 344 or other suitable machining insert holding tool is shown to have flats 342 extending along a substantial portion of the length thereof. The boring bar 344 is shown to have a head portion providing for support and positioning of a metal cutting insert 346. A machining system of conventional nature is provided with a tool holder 348 having a receptacle within which a portion of the boring bar is located. Set screws 350 extend through threaded openings and establish releasable retaining engagement with the boring bar as is evident from the longitudinal sectional view of FIG. 37. By engaging a flat surface of the boring bar maximum surface to surface contact of the set screws with the boring bar is achieved, thus providing for optimum retention and stabilization of the boring bar within the tool receptacle of the tool holder.

FIGS. 34 and 35 show a seal retaining bushing member 352 of tubular configuration which defines a circular seal receptacle within which is located an annular seal member 354 being composed of deformable resilient sealing material. The seal retaining bushing member 352 also defines an externally threaded flange 360 to which is threaded a seal retainer member 334 as shown in FIGS. 36 and 37. The seal retaining bushing member 352 is sized with respect to the external dimension of the boring bar and the internal dimension of the cylindrical internal surface 372 of the boring bar receptacle 374 and provides for efficient stabilization of the boring bar during machining processes. An external circular sealing member 362 is positioned within a circular seal receptacle that is located adjacent the externally threaded flange 360 of the seal retaining bushing member 352 and functions to establish sealing engagement within the internal surface 372 of the boring bar receptacle 374 of the tool holder 348 as is evident from FIG. 37. The seal retaining bushing member 352 defines an elongate slot 358 having curved ends, as shown in FIG. 35, through which two of the set screws 350 extend and establish clamping engagement with the upper flat surface of the boring bar.

With the boring bar positioned within the tool receptacle of the tool holder sealing between the tool bar and the bushing member 352 is established by the annular seal 362. For sealing to prevent leaking of cooling fluid along the flats of the boring bar an annular deformable resilient seal member 354 is positioned within the annular seal pocket of the bushing member and a seal retainer member 334 is threaded onto the threaded flange 360 and tightened sufficiently to deform the sealing member and fill the clearance areas between the flats of the boring bar and the internal cylindrical surface 372 of the tool receptacle 374. Tightening of the seal retainer may be accomplished manually or through use of a simple tool such as a spanner wrench. If desired, set screws may be employed to ensure against undesired rotational movement of the seal retainer due to the vibration of machining operations.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A coolant fluid supplying cutter insert holder and clamp, comprising:
an tool shank member having a cutter support head at one end thereof defining a cutter insert support seat and having a coolant fluid distribution passage therein;
a clamp member being retained in assembly with said cutter support head and securing a metal cutting insert in cutting position on said cutter insert support seat, said clamp member defining an internal coolant fluid flow passage in communication with said coolant fluid distribution passage and having at least one jet discharge outlet opening oriented to direct a discharge jet of coolant fluid onto a machining interface of a metal cutting insert with a workpiece, and
said internal coolant fluid flow passage of said clamp member being in fluid communication with said coolant fluid distribution passage of said cutter support head.

2. The coolant fluid supplying cutter insert holder and clamp of claim 1, comprising:
a retainer member securing said clamp member to said cutter support head and defining fluid communication of said coolant fluid distribution passage and said internal coolant fluid flow passage.

3. The coolant fluid supplying cutter insert holder and clamp of claim 1, comprising:
a retainer passage extending through said clamp member and intersecting said internal coolant fluid flow passage;
a threaded retainer receptacle being defined in said cutter insert support head and being in communication with said coolant fluid supply passage; and
a threaded retainer member extending through said retainer passage and being threaded into said threaded retainer receptacle, a coolant passage being defined by said threaded retainer member and establishing fluid communication of said coolant fluid supply passage and said internal coolant fluid flow passage;

4. The coolant fluid supplying cutter insert holder of claim 1, comprising:
an inclined surface being defined by said cutter support head;
a projection extending from said clamp member and engaging said inclined surface during tightening of said clamp member and developing a resultant rearward force on said clamp member which rearward force is applied to and causes forcible seating of a cutter insert on said cutter support head.

5. The coolant fluid supplying cutter insert holder of claim 1, comprising:
a coolant supply passage extending through said shank member to said cutter insert support head and having a fluid inlet opening;
a coolant fluid distribution passage being defined at least partially in said cutter insert support head and having fluid communication with said coolant supply passage; and
a retainer member securing said clamp member to said cutter support head and defining fluid communication of said coolant fluid distribution passage of said cutter support head and said internal coolant fluid flow passage of said clamp member.

6. The coolant fluid supplying machine tool holder of claim 1, comprising:
a retainer member securing said nozzle and clamp member in releasable assembly with said cutter support head; and
a coolant fluid passage being defined internally of said retainer member and establishing fluid communication of said coolant fluid distribution passage of said cutter support head with said internal coolant flow passage of said nozzle and clamp member and said internal fluid flow passage of said nozzle and clamp member.

7. The coolant fluid supplying machine tool holder of claim 1, comprising:
a clamp screw receptacle being defined in said cutter support head and having fluid communication with said internal coolant fluid distribution passage and with said internal clamp fluid flow passage, said clamp screw receptacle having an internally threaded section; and
a clamp retainer screw having a screw shank defining an externally threaded section being threaded into said internally threaded section of said clamp screw receptacle, said screw shank defining an internal fluid passage in communication with said coolant fluid distribution passage and in communication with said internal fluid flow passage of said nozzle and clamp member.

8. The coolant fluid supplying machine tool holder of claim 1, comprising:
a cutter insert receptacle being defined by said cutter support head and having cutter support shoulders;
an inclined surface being defined by said cutter support head;
a locking member depending from said nozzle and clamp member for engagement within an opening of a replaceable cutter insert;
a retainer screw securing said nozzle and clamp member to said cutter support head; and
said nozzle and clamp member defining a tapered surface having engagement with said inclined surface and upon tightening of said retainer screw member developing a pulling force causing said locking member to secure a replaceable cutter insert against said cutter support shoulders.

9. The coolant fluid supplying machine tool holder of claim 1, comprising:
a clamp screw receptacle being defined in said cutter support head and having fluid communication with said internal coolant fluid flow passage and with said internal clamp fluid flow passage, said clamp screw receptacle having an internally threaded section; and
a clamp retainer screw having a screw shank defining an externally threaded section being threaded into said internally threaded section of said transverse coolant fluid flow passage, said clamp retainer screw shank having annular clearance within said cutter support head defining an internal annular fluid passage externally of said screw shank and being in communication with said coolant fluid distribution passage of said cutter support head, said annular fluid passage also being in fluid communication with said internal fluid flow passage of said nozzle and clamp member.

10. The coolant fluid supplying machine tool holder of claim 1, comprising:
a coolant fluid distribution passage being defined in said cutter support head and having fluid communication with said internal coolant fluid supply passage and with said internal fluid flow passage of said nozzle and clamp member, said internal coolant fluid supply passage having a fluid inlet opening and defining a threaded receptacle at said coolant inlet opening,
a threaded connector of a coolant fluid supply conduit having threaded engagement within said threaded receptacle; and
a chip flush nozzle being mounted to said cutter support head and being in fluid communication with said coolant fluid distribution passage and directing a jet of coolant fluid to a location for removal of machine chips from a machining interface during machining operations.

11. The coolant fluid supplying boring bar of claim 1, comprising:
a clamp retainer screw member extending through said nozzle and clamp member and into said cutter support head and retaining said nozzle and clamp member in releasable cutter insert clamping assembly with said cutter support head;
a first seal member sealing said clamp retainer member with respect to said nozzle and clamp member and preventing leakage of coolant fluid; and
a second seal member sealing said nozzle and clamp member with respect to said cutter support head.

12. The coolant fluid supplying boring bar of claim 1, comprising:
said tool shank member having a plurality of flats thereon and being received within and defining clearance passages within a cylindrical tool receptacle of a machining system;
a seal support being disposed about said tool shank and having a seal receptacle and a deformable resilient seal being disposed within said seal receptacle; and
a seal retainer retaining said deformable resilient seal within said seal receptacle and causing compressive deformation of said seal to fill and seal said clearance passages and prevent leakage of coolant fluid.

13. A coolant fluid supplying machine tool holder, comprising:
an elongate shank member having an integral cutter support head at one end thereof and defining an internal coolant fluid supply passage extending within said elongate shank member and within said integral cutter support head;
a cutter support seat being defined by said integral cutter support head;
a nozzle and clamp member being releasably seated on said integral cutter support head and securing a metal cutting insert in cutting position on said cutter support seat, said nozzle and clamp member defining at least one internal fluid flow passage having at least one discharge outlet opening being located and oriented to direct at least one jet of coolant fluid from said internal fluid flow passage onto a metal cutting insert, and
a clamp retainer screw extending through said nozzle and clamp member and being threaded into said cutter support head and securing said nozzle and clamp member in releasable clamping engagement with said cutter support head and with a metal cutting insert, said clamp retainer screw and said cutter support head defining a flow passage in communication with said internal coolant fluid flow passage and with said internal coolant fluid supply passage.

14. The coolant fluid supplying machine tool holder of claim 13, comprising:
a coolant fluid passage being defined internally of said clamp retainer screw and having fluid communication with said internal coolant fluid flow passage of said nozzle and clamp member and with said internal coolant fluid supply passage of said elongate shank member.

15. The coolant fluid supplying machine tool holder of claim 13, comprising:
a coolant fluid passage being defined externally of said clamp retainer screw and having fluid communication with said internal coolant fluid flow passage and with said internal coolant fluid supply passage; and
said elongate shank member having a fluid inlet end having a fluid inlet opening and defining a threaded receptacle at said coolant inlet opening, said threaded receptacle receiving a threaded connector of a coolant fluid supply conduit.

16. The coolant fluid supplying machine tool holder of claim 13, comprising:
a coolant fluid distribution passage being defined at least partially in said cutter support head and having fluid communication with said internal coolant fluid flow passage and with said internal coolant fluid supply passage.

17. The coolant fluid supplying machine tool holder of claim 13, comprising:
a clamp screw receptacle being defined in said cutter support head and having fluid communication with said internal coolant fluid flow passage and with said internal clamp fluid flow passage, said clamp screw receptacle having an internally threaded section; and
said clamp retainer screw having a screw shank defining an externally threaded section being threaded into said internally threaded section of said transverse coolant fluid flow passage, said screw shank defining an internal fluid passage in communication with said coolant fluid distribution passage and having an outlet in communication with said internal fluid flow passage of said nozzle and clamp member.

18. The coolant fluid supplying machine tool holder of claim 13, comprising:
a clamp screw receptacle being defined in said cutter support head and having fluid communication with said internal coolant fluid distribution passage and with said internal fluid flow passage of said nozzle and clamp member, said clamp screw receptacle having an internally threaded section;
said clamp retainer screw having a screw shank defining an externally threaded section being threaded into said internally threaded section of said transverse coolant fluid flow passage, said clamp retainer screw shank having annular clearance within said cutter support head defining an internal annular fluid passage externally of said screw shank and being in communication with said coolant fluid distribution passage, said annular fluid passage also being in fluid communication with said internal coolant fluid flow passage; and
a chip flush member being mounted to said cutter support head and being in communication with said internal coolant fluid distribution passage, said chip flush member defining a discharge opening from which a jet of coolant fluid is projected for flushing machining chips from a machining interface with a work-piece.

19. The coolant fluid supplying machine tool holder of claim 13, comprising:
a coolant fluid distribution passage being defined in said cutter support head and having fluid communication with said internal coolant fluid supply passage and with said internal coolant fluid flow passage, said coolant fluid supply passage having a fluid inlet opening and defining a threaded receptacle at said coolant inlet opening, and
a threaded connector of a coolant fluid supply conduit having threaded engagement within said threaded receptacle.

20. The coolant fluid supplying machine tool holder of claim 13, comprising:
a clamp retainer screw extending through said clamp member and into said cutter support head and retaining said clamp member in releasable assembly with said cutter support head;
a first seal member sealing said clamp retainer member with respect to said nozzle and clamp member and preventing leakage of coolant fluid; and
a second seal member sealing said nozzle and clamp member with respect to said cutter support head.

21. The coolant fluid supplying machine tool holder of claim 13, comprising:
said tool shank member having a plurality of flats thereon and being received within and defining clearance passages within a cylindrical tool receptacle of a machining system;
a seal support being disposed about said tool shank and having a seal receptacle and a deformable resilient seal being disposed within said seal receptacle; and
a seal retainer retaining said deformable resilient seal within said seal receptacle and causing compressive deformation of said seal to fill and seal said clearance passages and prevent leakage of coolant fluid.

22. A coolant fluid supplying machine tool holder, comprising:
an elongate shank member having an integral cutter support head at one end thereof and defining an internal coolant fluid supply passage extending within said elongate shank member, said internal coolant fluid supply passage having a coolant inlet opening and an internally threaded receptacle;
said integral cutter support head defining a cutter support seat and defining a fluid distribution passage being in communication with said internal coolant fluid supply passage;
a nozzle and clamp member being releasably seated on said integral cutter support head for clamping retention of a metal cutting insert in cutting position on said cutter support seat, said nozzle and clamp member defining at least one internal coolant fluid flow passage having at least one discharge outlet opening being oriented to direct a discharge of coolant fluid from said internal coolant fluid flow passage onto a metal cutting insert immediately at a machining interface with a rotating work-piece,
said internal coolant fluid flow passage being in fluid communication with said fluid distribution passage; and
a clamp retainer screw extending through said nozzle and clamp member and being threaded into said cutter support head and securing said nozzle and clamp member in releasable clamping engagement with said cutter support head and with a metal cutting insert, said clamp retainer screw and said cutter support head defining a flow passage in communication with said internal coolant fluid distribution passage and with said internal clamp fluid flow passage.

23. The coolant fluid supplying machine tool holder of claim 22, comprising:
said cutter support seat of said integral cutter support head having cutter support shoulders;
said integral cutter support head defining a recess having an inclined surface;
said nozzle and clamp member defining a locking projection for engagement within an opening of a cutter insert and further defining a locking member having a tapered surface; and
during tightening of said clamp retainer screw said inclined surface and said tapered surface engaging and developing a pulling force pulling said locking member and forcing a cutter insert tightly against said cutter support shoulders.
